(19) United States
(12) Patent Application Publication
(10) Pub. No.: US 2024/0399743 A1
(43) Pub. Date: Dec. 5, 2024

(54) PRINTING APPARATUS, PRINTING METHOD, AND NON-TRANSITORY COMPUTER-READABLE RECORDING MEDIUM THEREFOR

(71) Applicant: BROTHER KOGYO KABUSHIKI KAISHA, Nagoya (JP)

(72) Inventor: Hiroya OKUWA, Kariya (JP)

(73) Assignee: BROTHER KOGYO KABUSHIKI KAISHA, Nagoya (JP)

(21) Appl. No.: 18/676,635

(22) Filed: May 29, 2024

(30) Foreign Application Priority Data
May 30, 2023 (JP) 2023-088647

(51) Int. Cl. B41J 2/045; B41J 2/175; B41J 2/21; B41J 3/407; D06P 5/30

(52) U.S. Cl. CPC B41J 2/04588; B41J 2/04581; B41J 2/04593; B41J 2/175; B41J 2/2117; B41J 2/2128; B41J 2/2132; B41J 3/4078; D06P 5/30

(57) ABSTRACT

A printing apparatus has first nozzles configured to eject ink to form a first base layer on a printing medium, second nozzles configured to eject ink to form a second base layer on the printing medium, and a controller. The controller is configured to perform a first printing to form the first base layer with the first nozzles based on first image data, the first image data representing a first dot density per one pass, a second printing to form the second base layer with the second nozzles based on second image data, the second image data representing a second dot density per one pass, the second dot density being lower than the first dot density, and increasing an ink amount when the second printing is performed such that an ink amount per dot is increased compared to a case where the first printing is performed.

### REFERENCE TO RELATED APPLICATIONS

This application claims priority from Japanese Patent Application No. 2023-088647 filed on May 30, 2023. The entire content of the priority application is incorporated herein by reference.

### BACKGROUND ART

The present disclosure relates to a printing apparatus, a printing method, and a non-transitory computer-readable recording medium containing computer-executable instructions for the printing apparatus.

Recently, DTG (Direct to Garment) printers have been developed. The DTG printers are configured to apply inkjet printing on fabrics. With a DTG printer, it is possible to print images on fabrics directly. In printing on fabrics, it is sometimes necessary to form a base layer of an image on the fabrics by ejecting a light-colored ink (typically, white ink). Since it is necessary that the base layer is formed over a relatively wide area of the fabric, a large amount of white ink is to be ejected at a high density.

### SUMMARY

However, due to a large amount of white ink being ejected, an effect of self-airflow caused by such ejection becomes stronger. Due to a relatively strong self-airflow, minute ink droplets generated during the printing of the base layer may adhere onto a nozzle surface of an ink ejection head as an ink mist. When the ink mist adheres to the nozzle surface, a so-called meniscus break may occur. When the meniscus break occurs at a nozzle, the ink droplet will not be ejected from the nozzle. Thus, according to the conventional configuration described above, it is sometimes difficult to obtain ejection stability.

According to aspects of the present disclosure, there is provided a printing apparatus configured to eject ink to form an image, including an ejection head which has first nozzles configured to eject ink to form a first base layer on a printing medium, second nozzles configured to eject ink to form a second base layer different from the first base layer on the printing medium, and a controller. The controller is configured to perform a first printing based on first image data, the first image data being data to form the first base layer, the first image data representing a first dot density per one pass, a second printing based on second image data, the second image data being data to form the second base layer, the second image data representing a second dot density per one pass, the second dot density being lower than the first dot density, and increasing an ink amount when the second printing is performed such that an ink amount per dot is increased compared to a case where the first printing is performed.

According to aspects of the present disclosure, there is also provided a printing apparatus configured to eject ink to form an image, including a first ejection head having first nozzles configured to eject ink to form a first base layer on a printing medium, a second ejection head having second nozzles configured to eject ink to form a second base layer different from the first base layer on the printing medium, and a controller. The controller is configured to perform a first printing using the first ejection head to form the first base layer based on first image data, the first image data representing a first dot density per one pass, a second printing using the second ejection head to form the second base layer based on second image data, the second image data representing a second dot density per one pass, the second dot density being lower than the first dot density, and increasing an ink amount when the second printing is performed such that an ink amount per dot is increased compared to a case where the first printing is performed.

According to aspects of the present disclosure, there is further provided a method of printing using a printing apparatus configured to eject ink to form an image, the printing apparatus having a first ejection head having first nozzles configured to eject ink to form a first base layer on a printing medium and a second ejection head having second nozzles configured to eject ink to form a second base layer different from the first base layer on the printing medium. The method including a first printing using the first ejection head to form the first base layer based on first image data, the first image data representing a first dot density per one pass, and a second printing using the second ejection head to form the second base layer based on second image data, the second image data representing a second dot density per one pass, the second dot density being lower than the first dot density. When the second printing is performed, the method causes the second nozzles to perform printing with increasing ink amount per dot compared to a case where the first printing is performed.

According to aspects of the present disclosure, there is provided a non-transitory computer-readable recording medium for a printing apparatus configured to eject ink to form an image, the printing apparatus having a first ejection head having first nozzles configured to eject ink to form a first base layer on a printing medium and a second ejection head having second nozzles configured to eject ink to form a second base layer different from the first base layer on the printing medium. The recording medium stores computer-executable instructions which cause, when executed by the controller, the printing apparatus to perform a first printing using the first ejection head to form the first base layer based on first image data, the first image data representing a first dot density per one pass, a second printing using the second ejection head to form the second base layer based on second image data, the second image data representing a second dot density per one pass, the second dot density being lower than the first dot density, and increasing an ink amount when the second printing is performed such that an ink amount per dot is increased compared to a case where the first printing is performed.

### BRIEF DESCRIPTION OF DRAWINGS

FIG. 1 is a plan view schematically showing a printing apparatus including ejection heads.

FIG. 2 is a block diagram showing a configuration of a control system of the printing apparatus.

FIG. 3 shows an example of a layout of nozzles on the ejection heads.

FIG. 4A shows an example of an image of a first base layer formed by basic color ink.

FIG. 4B shows an example of an image of a second base layer formed by white ink.

FIGS. 5A-5C illustrate an example of a dot density reduction process, and FIG. 5A shows an example of dot data, FIG. 5B shows an example of mask data, and FIG. 5C shows dot data obtained by applying the mask data of FIG. 5B to the dot data of FIG. 5A.

FIGS. 6A and 6B show a timing chart illustrating an example of an ink amount increase process.

FIGS. 7A and 7B show a timing chart illustrating another example of the ink amount increase process.

FIG. 8 is a graph illustrating a further example of the ink amount increase process.

FIG. 9 illustrates a further example of the ink amount increase process.

FIG. 10 illustrates still another example of the ink amount increase process.

FIG. 11 is a flowchart illustrating a process performed by a controller.

FIG. 12 illustrates another example of a dot density reduction process.

FIG. 13 is a plan view of a modification of the printing apparatus shown in FIG. 1.

### DESCRIPTION

Hereinafter, a printing apparatus 1 according to the present disclosure will be described with reference to the accompanying drawings. It should be noted that the printing apparatus 1 described below is merely an example of a printing apparatus according to aspects of the present disclosure. Thus, configurations according to aspects of the present disclosure are not necessarily limited to the configurations of the embodiment and modifications described below, but further modifications can be made without departing from aspects of the present

### DISCLOSURE

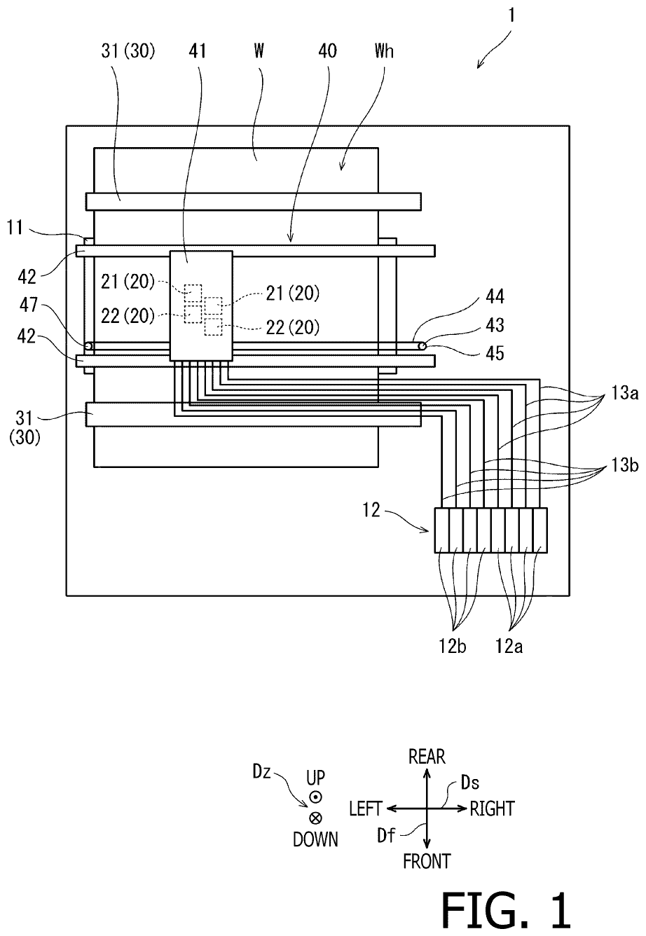

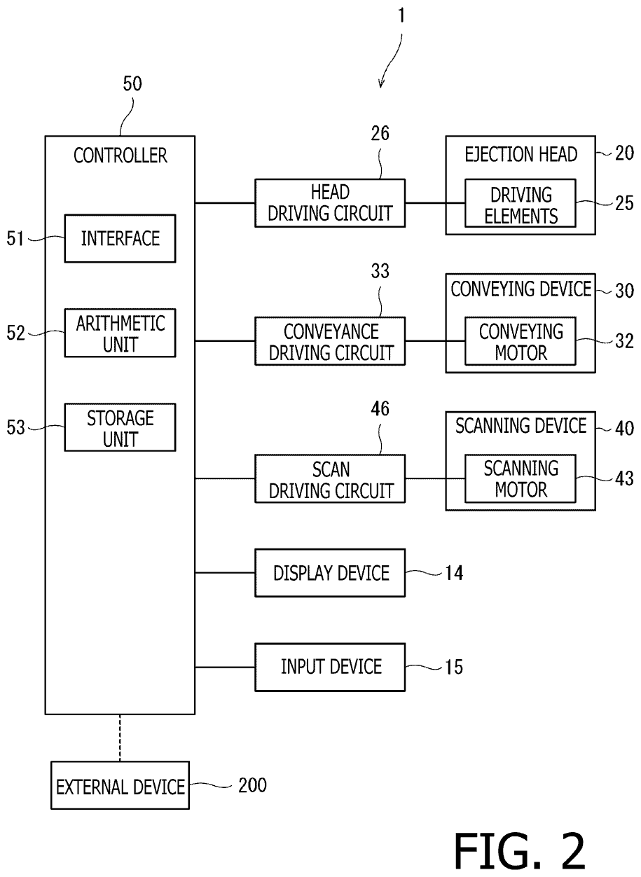

FIG. 1 is a plan view schematically showing a configuration of the printing apparatus 1 according to the present disclosure. FIG. 2 is a block diagram showing a configuration of a control system of the printing apparatus 1. In the following description, a first direction Ds and a second direction Df, which are orthogonal to each other, will be referred to (see FIG. 1). The first direction Ds is, for example, a direction in which a carriage 41 moves, while the second direction Df is, for example, a direction in which a printing medium W is conveyed. In the following description, the first direction Ds is also referred to as a moving direction, and the second direction Df is also referred to as a conveying direction. In FIG. 1, an up-down direction Dz, which is a direction perpendicular to a plane of FIG. 1, is also indicated.

The printing apparatus 1 according to the present disclosure is an inkjet printer, which is configured to perform printing on a printing medium W. It is noted that the printing medium may be not only on paper but also fabrics. The printing apparatus 1 shown in FIG. 1 is of a serial head type and has multiple ejection heads 20, a platen 11, multiple tanks 12, a conveying device 30, and a scanning device 40.

It is noted that the printing apparatus I may be of a line-head type. In such a modification, the printing apparatus 1 is not provided with the scanning device 40, while the each ejection head 20 has a dimension longer than a length, in the moving direction Ds, of a printing area on the printing medium W and is configured not to move.

The ejection heads 20 are configured to print an image on the printing medium W with particular inks based on image data. The ejection heads 20 include, for example, two first ejection heads 21 and two second ejection heads 22. It is noted that the first ejection heads 21 are examples of a first ejection head according to aspects of the present disclosure, and the second ejection heads 22 are examples of a second ejection head according to aspects of the present disclosure. The first ejection heads 21 are configured to perform printing on the printing medium W with basic color inks (described later). The second ejection heads 22 are configured to perform printing on the printing medium W with white ink. The platen 11 has a planar upper surface, and a particular distance is defined between the printing medium W placed on the upper surface of the platen 11 and lower surfaces (i.e., the surfaces facing the printing medium W) of the ejection heads 20.

In the tanks 12, multiple color inks are stored. The tanks 12 are connected to the ejection heads 20 via flow channels to supply the inks to the ejection heads 20. The tanks 12 are containers for storing the multiple color inks, the number of which is equal to or greater than the number of ink colors. For example, the tanks 12 include four first tanks 12a respectively storing inks of four basic colors, and one or more second tanks 12b storing the white ink. It is noted that a cyan ink, a yellow ink, a magenta ink, and a black ink are examples of the basic color inks.

As described above, the first tanks 12a are configured to store the basic color inks and are connected to the first ejection heads 21 through first flow channels 13a, and the basic color inks are supplied from the first tanks 12a to the first ejection heads 21 via the first flow channels 13a. The second tanks 12b are connected to the second ejection heads 22 through the second flow channels 13b. When the white ink is stored in the second tank 12b, the white ink flows from the second tanks 12b into the second channels 13b and is supplied to the second ejection heads 22. In terms of material of the ink flow channels 13b, it is preferable that the first channels 13a and the second channels 13b are bend-resistant and, for example, made of rubber or plastic tubes.

According to the present disclosure, the conveying device 30 has two conveying roller pairs 31 (see FIG. 1) and a conveying motor 32 (see FIG. 2). Each of the conveying roller pairs 31 include a pair of cylindrical rollers disposed in the up-down direction Dz such that the printing medium W is sandwiched between the two cylindrical rollers of each of the conveying roller pairs 31, and each cylindrical roller has a rotation axis extending in the moving direction Ds. The two conveying roller pairs 31 are arranged in a conveying direction Df with the platen 11 located therebetween. In the present embodiment, the conveying direction Df corresponds to a crossing direction according to aspects of the present disclosure. One of the cylindrical rollers of each conveying roller pair 31 is connected to the conveying motor 32. As the conveying motor 32 is driven, each of the cylindrical rollers connected to the conveying motor 32 is driven to rotate about its rotation axis, thereby the printing medium W is conveyed, on the platen 11, in the conveying direction Df.

The scanning device 40 has a carriage 41, two guide rails 42, a scanning motor 43 (see FIG. 2 also), and an endless belt 44. The two guide rails 42 are arranged so as to sandwich the ejection heads 20, in the conveying direction Df, and parallelly extend in the moving direction Ds above the platen 11. The carriage 41 holds the multiple ejection heads 20, and is supported by the two guide rails 42 so as to be slidable in the moving direction Ds. The endless belt 44 extends in the moving direction Ds, and is wound around pulleys 45 and 47 (see FIG. 1). The carriage 41 is secured to the endless belt 44, and the endless belt 44 is connected to the scanning motor 43 via the pulley 45. Thus, when the scanning motor 43 is driven, the endless belt 44 runs (i.e., moves mainly in the moving direction Ds). Accordingly, the carriage 41 is driven to move reciprocally in the moving direction Ds as guided by the guide rails 42. In this way, the carriage 41 moves the ejection heads 20 in the moving direction Ds.

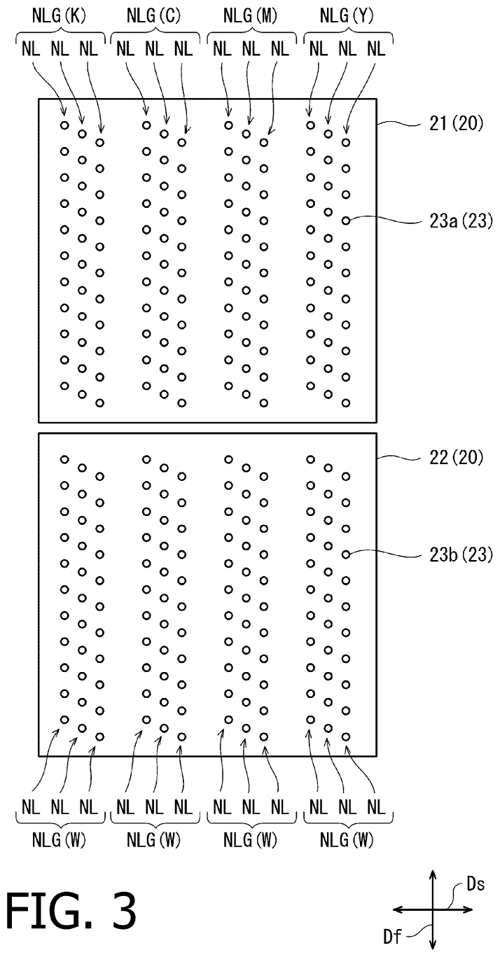

The ejection heads 20 has multiple driving elements 25. Each driving element 25 includes a piezoelectric element, which is disposed in correspondence with each nozzle 23 of each ejection head 20 (see FIG. 3), and applies ejection pressures the ink so that ink droplets are ejected from the nozzles 23, respectively. It is noted that the driving elements 25 are examples of actuators according to aspects of the present disclosure.

The printing apparatus 1 is further provided with a display device 14, an input device 15 and a controller 50. The controller 50 is an example of a computer according to aspects of the present disclosure, and has an interface 51, an arithmetic unit 52, and a storage unit 53. Each of the interface unit 51, the arithmetic unit 52, and the storage unit 53 has hardware configurations, respectively. The controller 50 performs an ink amount increase process, which will be described in detail later. The interface 51 is configured to receive various types of data such as image data from external devices 200 such as computers, cameras, communication networks, recording media, displays and printers. The image data is typically raster data, or the like, that represents an image to be printed on the printing medium W, and includes information on particular printing conditions. It should be noted that the controller 50 may be configured as a single device. Alternatively, multiple devices may be provided in a distributed manner so that they work together to control operations of the printing apparatus 1.

The storage unit 53 is a memory accessible from the arithmetic unit 52 and includes a RAM and a ROM. The RAM is configured to temporarily store various types of data, including data received from the external device 200, such as image data, and data converted by the arithmetic unit 52. It should be noted that the printing program may be stored in an external storage medium, which is different from the storage unit 53 and accessible from the arithmetic unit 52, examples of which may be a USB flash memory, a CD-ROM, or the like.

The arithmetic unit 52 includes at least one circuit, i.e., a processor such as a CPU or an integrated circuit such as an ASIC. The arithmetic unit 52 controls each part of the printing apparatus 1 by executing a print program to perform various operations such as a printing operation. In the present embodiment, the arithmetic unit 52 corresponds to a first print processor, a second print processor, and an ink amount increase controller according to aspects of the present disclosure.

The display device 14 is, for example, an LCD, which is configured to display images represented by the image data according to instructions of the controller 50. The input device 15 is, for example, an operation panel provided with operation buttons, which are to be operated by a user. It should be noted that the display device 14 may not display an image that is exactly the same as the image to be printed on the printing medium W by the ejection heads 20. However, even if the displayed image is not exactly the same as the image to be printed, the displayed image will be regarded to be effectively or substantially the same as the image to be printed. Optionally, the input device 15 may be a touch panel integrated with the display device 14.

The controller 50 is electrically connected to the conveying motor 32 of the conveying device 30 via a conveyance driving circuit 33 and controls the operation of the conveying motor 32. In this way, the conveyance of the printing medium W by the conveying device 30 is controlled. Further, the controller 50 is electrically connected to the scanning motor 43 of the scanning device 40 via a scan driving circuit 46 and controls the operation of the scanning motor 43. In this way, the movement of the ejection heads 20 by the scanning device 40 is controlled. Furthermore, the controller 50 is electrically connected to the driving elements 25 via a head driving circuit 26. The controller 50 outputs control signals for the driving elements 25 to the ejection head driving circuit 26, and the head driving circuit 26 generates drive signals based on the control signals and outputs the drive signals to the driving elements 25, respectively. The driving elements 25 are driven in response to the drive signals, causing ink droplets to be ejected through the nozzles 23.

In the printing apparatus 1 having the above-described configuration, the controller 50 obtains image data and executes a printing operation in accordance with the image data. In such a case, in one printing pass, the controller 50 moves the ejection heads 20 in the moving direction Ds, while causing the ejection heads 20 to eject ink droplets from the nozzles 23 onto the printing medium W. Then, the controller 50 moves the printing medium W to the front. In this way, the printing apparatus 1 alternately performs the printing passes and the conveying operations, thereby an image represented by the image data being printed on the printing medium W.

FIG. 3 shows an example of the arrangement of the nozzles 23 on the ejection heads 20 (i.e., on the ejection head 21 and the ejection head 22). FIG. 3 shows only one of the first ejection heads 21 and one of the second ejection heads 22, which are shown in FIG. 1.

The first ejection head 21 and the second ejection head 22 are aligned in the conveying direction Df. On the first ejection head 21, first nozzles 23a are provided, while on the second ejection head 22, second nozzles 23b are provided. It is noted that a configuration in which multiple first nozzles 23a and multiple second nozzles 23b are provided to each ejection head may be adopted.

To one of the first ejection heads 21, multiple (four in the example shown in FIG. 3) nozzle line groups NLG are provided. One nozzle line group NLG includes multiple (three in the example shown in FIG. 3) nozzle lines NL. One nozzle line NL has multiple nozzles 23 which are formed at approximately equal intervals in the conveying direction Df.

The nozzles 23 of one nozzle line NL and the nozzles 23 of an adjacent nozzle line NL are shifted, in the moving direction Ds, by a particular amount. In other words, the nozzles 23 of one nozzle line NL and the nozzles 23 of the adjacent nozzle line NL are formed at different positions in the conveying direction Df.

Further, the nozzle line groups NLG in each of the first ejection heads 21 are arranged at approximately equal intervals in the moving direction Ds.

From one end of the moving direction Ds (from the left-hand side in FIG. 3), the following nozzle line groups NLG are arranged: a nozzle line group NLG configured to eject the black ink, a nozzle line group NLG configured to eject the cyan ink, a nozzle line group NLG configured to eject the magenta ink, and a nozzle line group NLG configured to eject the yellow ink. In FIG. 3, the color of the ink to be ejected by each nozzle ling group NLG is indicated by letters K (black), C (cyan), M (magenta) and Y (yellow) in parentheses.

The first nozzles 23a, which are the nozzles 23 formed on the first ejection head 21, are configured to eject the basic color inks to perform printing on the printing medium W in order to form a first base layer on the printing medium W.

The configuration of the second ejection head 22 is basically the same as that of the first ejection head 21. On the second ejection head 22, multiple (four in FIG. 3) nozzle line groups NLG are arranged. The second nozzles 23b, which are the nozzles 23 formed on the second ejection head 22, are configured to eject the white ink to perform printing on the printing medium W to form a second base layer different from the first base layer on the medium W. The multiple second nozzles 23b are aligned in the conveying direction Df to form a nozzle line NL, and the nozzle lines NL are aligned in the moving direction Ds. In FIG. 3, all the nozzle line groups NLG are configured to eject the white ink and a letter W (white) is indicated in parentheses.

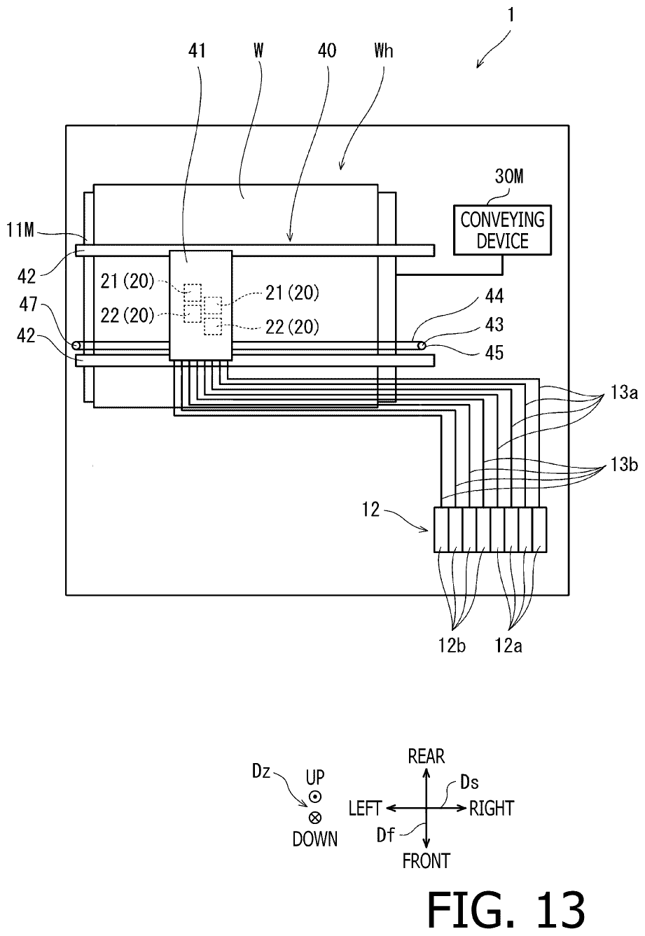

FIG. 13 shows a plan view of a modification of the printing apparatus 1 shown in FIG. 1. The modification shown in FIG. 13 is configured such that, in comparison with the printing apparatus 1 shown in FIG. 1, the conveying roller pairs 31 are not provided, and the platen 11 is replaced with a platen 11M, which is configured to be driven by a conveying device 30M to move in the front-rear direction. That is, according to the modified printing apparatus 1, the printing medium W is fixed onto the platen 11M, and the platen 11M itself is driven to reciprocally move in the front-rear direction. According to the modified printing apparatus 1 shown in FIG. 1, formation of a first base layer Ga1 with the base color inks, formation of a second base layer Ga2 with the white ink, and formation of a color image according to the image data can be performed subsequently by reciprocally moving the platen 11M. It is noted that, depending on the color of the printing medium W, the formation of the first base layer Ga1 may be omitted.

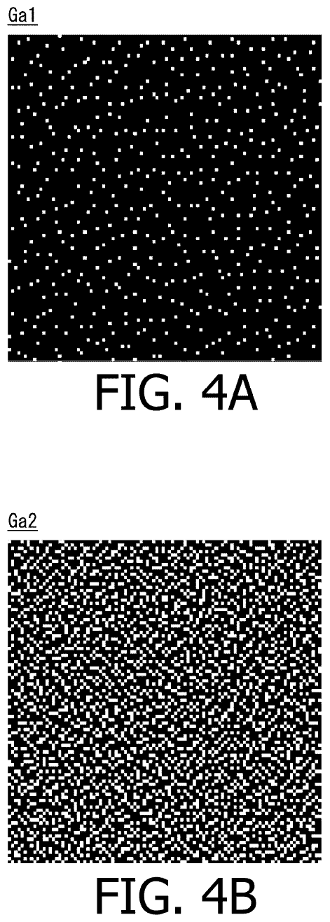

FIG. 4A illustrates an example of an image Ga1 of the first base layer formed with the base color inks in accordance with the first image data, and FIG. 4B illustrates an example of an image Ga2 of the second base layer formed with the white ink in accordance with the second image data.

The controller 50 is configured to perform a first printing process in which the controller 50 performs printing based on the first image data to form the first base layer. The image Ga1 shown in FIG. 4A is an image pertaining to the first base layer and is formed based on the first image data. Further, the controller 50 is configured to perform a second printing process in which the controller 50 performs printing based on the second image data, which is the image data to form the second base layer. The image Ga2 illustrated in FIG. 4B is an image pertaining to the second base layer and is formed based on the second image data. The dot density per one pass obtained from the second image data is lower than the dot density obtained from the first image data. The dot density is defined as the number of dots that are formed per inch. It should be noted that, throughout the specification, the term “dot density” is used to mean the number of dots per 1 inch, or the number of dots per 1 square inch, depending on the context.

In FIG. 4A and FIG. 4B, the black areas represent areas where dots have been formed by the ink, and the white areas represent areas where no dots have been formed. As described above, the dot density per one pass when the second base layer is printed based on the second image data is lower than the dot density per one pass when the first base layer is printed based on the first image data. Therefore, the image Ga2 illustrated in FIG. 4B has more white areas (i.e., more non-printed areas) than the image Ga1 shown in FIG. 4A.

For example, when the first base layer is printed with the inks of the basic colors, the dot density is 1200 dpi. Therefore, the total number of dots that can be formed in an area with a dimension of 1 inch in the moving direction Ds and 1 inch in the conveying direction Df is 1.44 million dots. When printing the second base layer with white ink, the dot density can be determined so that the total number of dots formed in the above area is, for example, 1,440,000×(100−Y)/100, where Y is a particular value. If the white ink is ejected in all pixels for 100% density, the printing media will be soaked with the ink. When an ink droplet lands on the printing medium, it spreads out to a certain extent. Therefore, 100% density can be achieved while thinning out a portion of all dots to the extent that the printing medium can accept the ink. The value indicating the percentage of such white dots, i.e., the percentage of white dots in the total number of dots, is represented by Y.

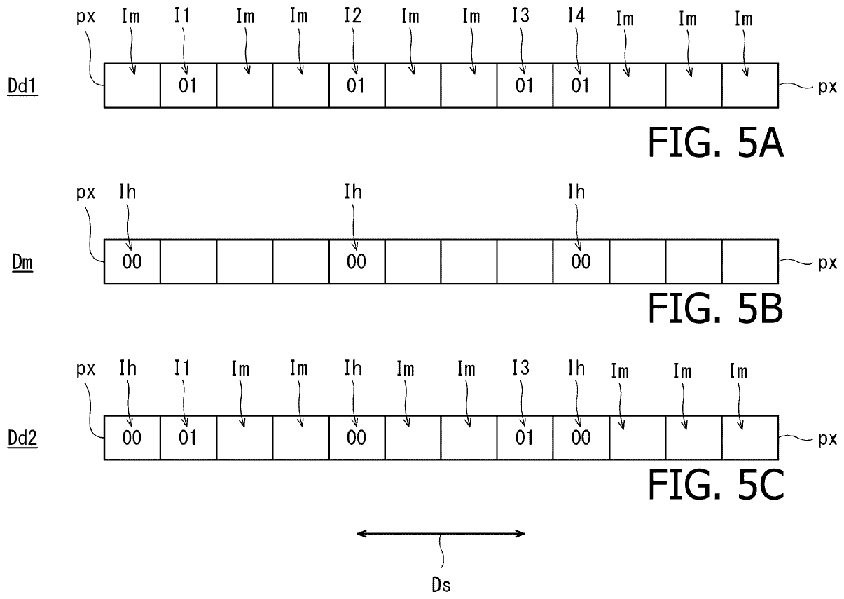

Next, an example of a process performed in the second printing process to reduce the dot density per pass (hereinafter referred to as a “dot density reduction process”) when printing is performed based on the second image data compared to a case where printing is performed based on the first image data will be described. FIGS. 5A-5C illustrate an example of the dot density reduction process. That is, FIG. 5A shows an example of dot data, FIG. 5B shows an example of mask data, and FIG. 5C shows dot data obtained by applying the mask data of FIG. 5B to the dot data of FIG. 5A.

As shown in FIG. 5A, the dot data Dd1 is configured such that, for example, four pieces of ejection dot information I1 to I4 are provided in the multiple pixels px aligned in the moving direction Ds. The ejection dot information I1 to I4 are information indicating that ink droplets should be ejected, respectively. Further, each of blank portions (i.e., pixels) in the dot data Dd1 are indicated to be no-dot information Im. The no-dot information Im is information indicating that ink droplets should not be ejected (i.e., no dot is to be formed).

The controller 50 applies the mask data Dm of FIG. 5B to the dot data Dd1 of FIG. 5A. The mask data Dm has non-ejection information Ih in any of the multiple pixels px. When such mask data Dm is applied to the dot data Dd1, the ejection dot information 12 and 14, which have the same position in the movement direction Ds as the non-ejection information Ih in the mask data Dm, among the ejection dot information I1 to I4 in the dot data Dd1, are masked and converted to non-ejection information Ih. In this way, new dot data Dd2 with reduced dot density compared to the dot data Dd1 is generated. As described above, the dot density reduction process, in which the dot density per pass can be reduced, is performed.

In the dot density reduction process, the controller 50 causes the second nozzles 23b to perform printing so that the dot density per pass is lower than a case where printing is performed based on the first image data at irregular positions (i.e., randomized positions) in the printing area Wh (FIG. 1) of the printing medium W. In such a case, the controller 50 can use random numbers for each pass to randomize the positions of the non-ejection dot information Ih in the mask data Dm described above. By applying the mask data Dm, in which the position of non-ejection dot information Ih is randomized for each pass, to the dot data Dd1, it is possible to reduce the dot density at irregular positions in the printing area Wh of the printing medium W. According to a modified embodiment, the mask data Dm for the entire base image is generated such that the dots to be masked are determined randomly. It is noted that the randomization may be performed on a one-dimensional basis, or a two-dimensional basis. Regarding the randomization, various methods have been suggested, and details description on the randomization will not be provided.

When the dot density of ink droplets ejected by the second nozzle 23b based on the second image data exceeds the particular reference dot density, the controller 50 executes the dot density reduction process described above and an ink amount increase process described below. The reference dot density may be 9.5×10⁵ (dots/inch²), for example. The reference dot density is stored in the memory section 53.

The controller 50 performs the ink amount increase process to cause the second nozzles 23b to print with more ink per dot than when printing based on the first image data in the second printing process is performed. Hereafter, the ink amount increase process by the controller 50 will be described using several examples.

As an example of the ink amount increase process, the controller 50 may perform an overlapping ejection process, in which an ink droplet ejected later by another second nozzle 23b overlaps the landing position of the ink droplet ejected earlier by a second nozzle 23b.

As an example of the ink amount increase process, the controller 50 may perform an overlapping ejection process in which landing positions of ink droplets ejected later by second nozzles 23b overlap the landing positions of the ink droplets ejected previously by other second nozzles 23b. In such a case, the ratio of the number of overlapping ejections to the total number of ejections by the second nozzles 23b in the ink amount increase process is higher than the ratio of the number of overlapping ejections to the total number of ejections by the first nozzles 23a when printing is performed based on the first image data. In this way, it is possible to increase the ink amount per dot in the ink amount increase process compared to a case where printing is performed based on the first image data.

Alternatively, the controller 50 may differentiate ejection waveforms to drive the driving elements 25 corresponding to the second nozzles 23b from the ejection waveforms to drive the driving elements 25 corresponding to the first nozzles 23a, when the ink amount increase process is performed. Such an example will be described in detail below.

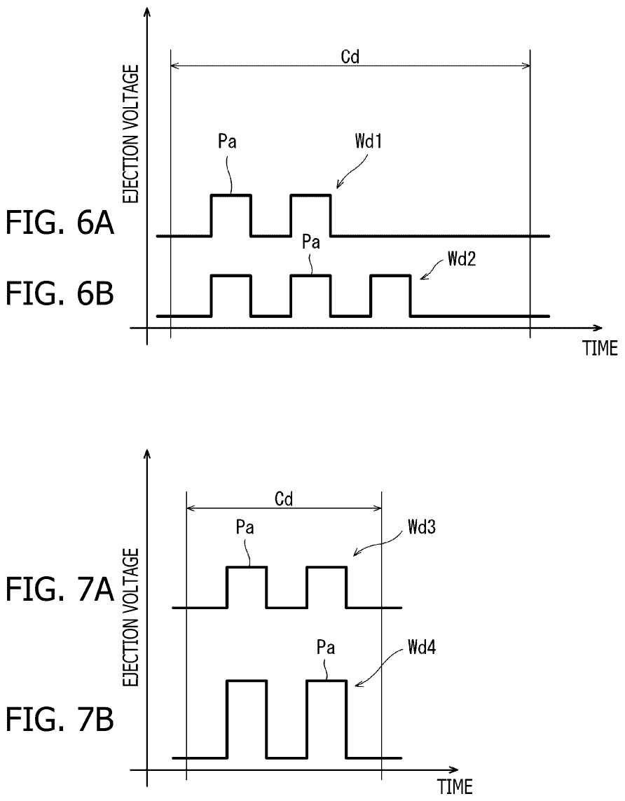

FIGS. 6A and 6B show an example of the ink amount increase process. FIGS. 7A, 7B, 8, 9 and 10 show other examples of the ink amount increase process.

As shown in FIGS. 6A and 6B, the controller 50 increases the number of pulses Pa in an ejection period Cd included in an ejection waveform Wd2 for driving the driving element 25 corresponding to the second nozzle 23b (see FIG. 6B) to be more than the number of pulses Pa in the ejection period Cd included in an ejection waveform Wd1 to drive each of the drive elements 25 corresponding to the first nozzles 23a (see FIG. 6A). In this way, the ink amount per dot can be increased.

It is preferable that the ink amount increase process is performed such that the ink amount after the increase is a value calculated by an equation indicated below.

Ink amount after increase=(normal ink amount)×((dot density before execution of dot density reduction process)/(dot density after execution of dot density reduction process))

Alternatively, the ink amount per dot may be increased as described below.

As shown in FIGS. 7A and 7B, the controller 50 increases the ejection voltage (i.e., a signal intensity level) of the pulse Pa in an ejection waveform Wd4, which drives the drive element 25 corresponding to the second nozzle 23b (see FIG. 7B), to be more than the ejection voltage of the pulses Pa of an ejection waveform Wd3, which drives the drive element 25 corresponding to the first nozzle 23a (see FIG. 7A). In this way, the ink amount per dot can also be increased.

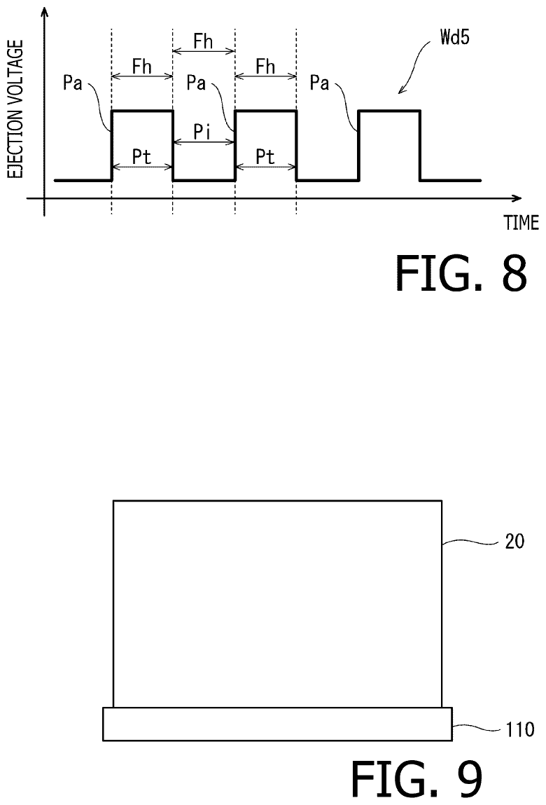

Further alternatively, as shown in FIG. 8, the controller 50 generates an ejection waveform Wd5 so that a period Pt of the pulse Pa of the ejection waveform Wd5 that drives the driving device 25 corresponding to the second nozzle 23b coincides with a period Fh of a natural oscillation of the driving device 25 concerned. In this case, the controller 50 generates the ejection waveform Wd5 so that a period Pi of an interval between one adjacent pulse Pa and the other pulse Pa is roughly equal to the period Fh of the natural oscillation of the driving element 25. In this way, the size of the ink droplet ejected from the second nozzle 23b can be increased, thereby increasing the ink amount per dot.

Still alternatively, the controller 50 may generate the ejection waveform Wd5 so that the period Pt of the pulse Pa of the ejection waveform Wd5 that drives the driving element 25 corresponding to the second nozzle 23b is approximately equal to one half (i.e., a half period) of the period Fh of the natural oscillation of the driving element 25. Also in this way, the size of the ink droplet ejected from the second nozzle 23b can be increased, resulting in an increase in the ink amount per dot.

Further alternatively, in the ink amount increase process, the controller 50 may increase the temperature of the ink to be ejected from the second nozzles 23b more than the temperature of the ink to be ejected from the first nozzles 23a. As shown in FIG. 9, a film heater 110 is wrapped around the periphery of the ejection head 20. In this way, the heater 110 heats the ejection head 20, and the ejection head 20 heats the ink in the channels in the ejection head 20. The ink viscosity decreases as temperature rises, resulting in an increase in discharge volume even with the same amount of deformation of the driving element. Accordingly, the volume of ink droplets ejected from the second nozzles 23b can be increased, resulting in an increase in the ink amount per dot.

As a configuration to increase the temperature of the ink, the following configuration may be adopted.

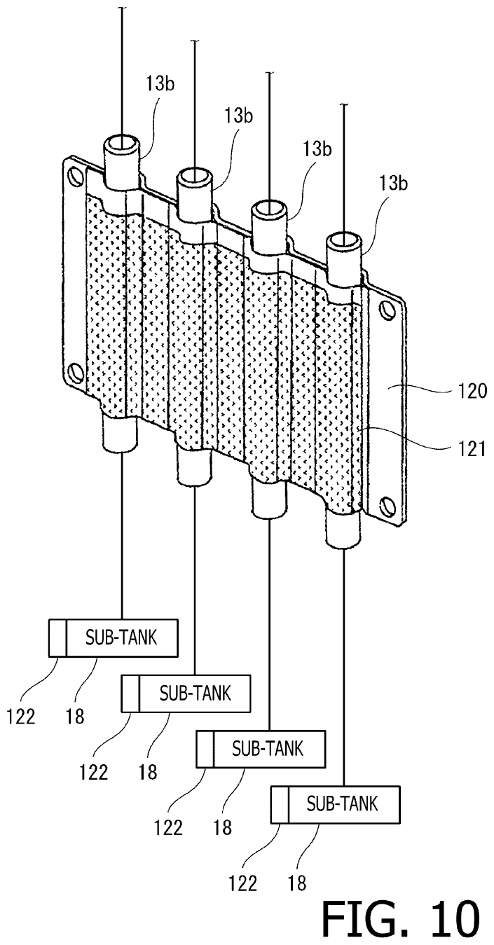

As shown in FIG. 10, four second flow channels 13b connected to the second ejection head 22 are secured to a fixture 120. The second flow channels 13b are examples of an ink flow channel according to aspects of the present disclosure. The fixture 120 has one plate with four depressions covering half of the outer circumference of each second channel 13b and the other plate of the same shape as that one plate, which are coupled to each other by surface contact. The fixture 120 is provided with a film-like heater 121 configured to heat each second flow channel 13b. In this way, the volume of ink droplets ejected from the second nozzles 23b can be increased, resulting in an increase in the ink amount per dot.

Optionally, a sub-tank 18 may be provided in a portion of each second flow channel 13b that is downstream of the heater 121 and upstream of the second ejection head 22 to supply ink to be ejected from the second nozzle 23b to said second nozzle 23b. It is noted that the sub-tank 18 is an example of a supply source, or a supply tank according to aspects of the present disclosure. A film heater 122 is attached to the outer circumference of the sub-tank 18. The controller 50 is configured to heat each of the sub-tanks 18 with the heater 122, thereby heating the ink in the sub-tanks 18. Thus, the volume of ink droplets ejected from the second nozzles 23b can be increased. It should be noted that only one of the heaters 121 and 122 may be provided, or both of them may be provided.

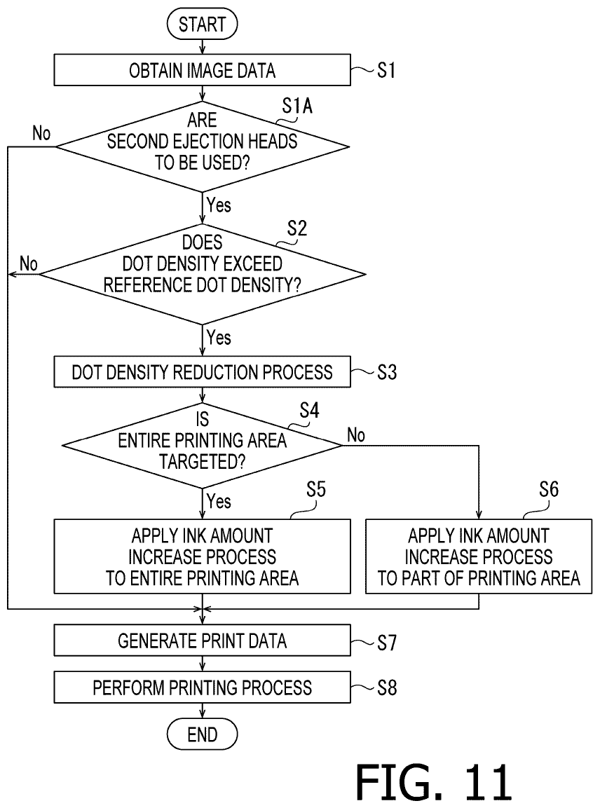

FIG. 11 is a flowchart showing a process by the controller 50. The controller 50 obtains image data from an external device 200 (S1). The image data is an example of image data according to aspects of the present disclosure. Next, the controller 50 determines whether the second ejection heads 22 are to be used for printing based on the obtained image data (SIA). When it is determined that the second ejection heads 22 are not used (SIA: NO), the controller 50 proceeds to S7. It is noted that, since one nozzle line group NLG is assigned to one color in each of the first ejection heads 21, it is less likely that the ink mist is adhered onto the nozzle surface of the first ejection head 21 even if the dot density is relatively large. Therefore, when the first ejection heads 21 are used for printing, the dot density reduction process (S3) and the ink amount increase process (S5 or S6) are not performed. When it is determined that the second ejection heads 22 are to be used (SIA: YES), the controller 50 determines whether a dot density of the ink droplets to be ejected by the second nozzles 23b obtained from the image data exceeds a reference dot density that serves as a threshold value (S2).

When the dot density of ink droplets ejected by the second nozzle 23b based on the image data exceeds the reference dot density (S2: YES), the controller 50 executes, in S3, the dot density reduction process described above. It is noted that the image data of which dot density is determined to exceed the reference dot density in S2 (S2: YES) will be referred to as second image data. By performing the dot density reduction process, the dot density per pass can be lower than the case where the ink droplets are ejected based on the first image data.

Next, based on the second image data, the controller 50 determines whether a target of the ink amount increase process is an entire printing area Wh of the printing medium W (S4). For example, the controller 50 may determine that the target of the ink amount increase process is the entire printing area Wh when a base layer is formed over the entire printing area Wh. The controller 50 may determine that the target of the ink amount increase process is a partial printing area Wh when a base layer is formed only in the background of the text portion of the printing area Wh.

When the target of the ink amount increase process is the entire printing area Wh of the printing medium W (S4: YES), the controller 50 executes the ink amount increase process described above for the entire printing area Wh (S5). On the other hand, when the target of the ink amount increase process is a part of the printing area Wh of the printing medium W (S4: NO), the controller 50 executes the ink amount increase process for the part of the printing area Wh (S6).

When the second ejection heads 22 are not to be used (SIA: NO), when the dot density of ink droplets ejected by the second nozzles 23b based on the image data does not exceed the reference dot density (S2: NO), after execution of S5, or after execution of S6, the controller 50 generates print data based on the second image data (S7). It is noted that the image data of which dot density is determined not to exceed the reference dot density in S2 (S2: NO) will be referred to as third image data. Then, the controller 50 performs the printing process on the printing medium W based on the print data (S8).

As described above, according to the printing apparatus 1, when performing printing based on the second image data, the dot density per pass is lower than that based on the first image data, so the number of ink droplets ejected can be reduced compared to the case where printing is performed based on the first image data. This can suppress the effect of self-airflow generated by ejection, thereby preventing the micro-droplets of ink generated during printing from adhering to the nozzle surface of the ejection head 20. As a result, meniscus breakage of the nozzles 23 can be suppressed, and thus ejection stability can be achieved. Further, although the dot density is lowered as described above, the ink amount per dot is increased by the ink amount increase process. Thus, it is possible to prevent or suppress printed images from becoming low-definition. In summary, by reducing the number of ink droplets ejected to suppress the effect of self-airflow, while by increasing the ink amount per dot, it is possible to ensure ejection stability and prevent the printed image from becoming low-definition. In other words, by reducing the dot density when printing the base layer that should be uniform, it is possible to prevent unevenness in thickness.

Further, in the present embodiment, the controller 50 causes the second nozzle 23b to perform printing so that the dot density per pass is lower than the dot density of the first image data at irregular positions in the printing area Wh of the printing medium W in the ink amount increase process. By lowering the dot density at irregular positions in this manner, it is possible to prevent generation of areas where the dot density is unbalanced. Therefore, it is possible to prevent the unbalanced occurrence of areas with a large number of ink ejections, thereby suppressing the effects of self-airflow.

Further, in the present embodiment, a ratio of the number of overlapping ejections to the total number of ejections by the plurality of second nozzles 23b in the ink amount increase process is higher than a ratio of the number of overlapping ejections to the total number of ejections by the plurality of first nozzles 23a when printing based on the first image data. In this way, the ink amount per dot can be increased without increasing the total number of ejections by the second nozzles 23b. Therefore, it is possible to prevent or suppress printing images from becoming low-definition while suppressing the effects of self-airflow.

Further, in the present embodiment, the controller 50 makes the ejection waveform for driving the driving elements 25 corresponding to the second nozzles 23b in the ink amount increase process different from the ejection waveform for driving the driving elements 25 corresponding to the first nozzles 23a. Concretely, the controller 50 may increase the number of pulses included in the ejection waveform for driving the driving elements 25 corresponding to the second nozzles 23b over the number of pulses included in the ejection waveform for driving the driving elements 25 corresponding to the first nozzles 23a. In this way, it is possible to easily increase the ink amount per dot when performing printing based on the second image data.

Alternatively or optionally, in the present embodiment, the controller 50 may superimpose an ejection waveform for driving the driving elements 25 corresponding to the second nozzles 23b in the ink amount increase process. In this way, the ink amount per dot can be easily increased when printing based on the second image data.

Alternatively or optionally, in the present embodiment, the controller 50 may increase the ejection voltage in the ejection waveform for driving the driving elements 25 corresponding to the second nozzles 23b in the ink amount increase process more than the ejection voltage in the ejection waveform for driving the driving elements 25 corresponding to the first nozzles 23a. In this way, the ink amount per dot can be easily increased when performing printing based on the second image data.

Further alternatively, in the present embodiment, the controller 50 may increase the temperature of the ink to be ejected from the second nozzles 23b in the ink amount increase process to a higher temperature than that of the ink to be ejected from the first nozzles 23a. Concretely, the controller 50 may heat the ink to be ejected from the second nozzles 23b by the ejection head 20. In this way, thermal expansion can be induced in the ink, thereby increasing the volume of ink droplets ejected from the second nozzles 23b. Thus, the ink amount per dot can be easily increased.

Still alternatively or optionally, in the present embodiment, the controller 50 may heat the ink with the sub-tanks 18. This can also easily increase the ink amount per dot.

Further alternatively or optionally, in the present embodiment, the controller 50 may heat the second flow channels 13b, which are the ink channels, by means of a heater 121. This can also easily increase the ink amount per dot.

Further, in the present embodiment, the controller 50 executes the ink amount increase process (S5, S6) when the dot density of ink droplets ejected by the second nozzles 23b per pass based on the second image data exceeds a particular reference dot density (S2: YES). In such a case, the criterion for determining whether or not the ink amount increase process should be executed is clarified.

While aspects of the present disclosure have been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting aspects of the present disclosure. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations according to the present disclosure are provided below.

In the above-described embodiment, the dot density reduction process is performed by applying mask data Dm to the dot data Dd1. However, a process to reduce the dot density is not necessarily limited to the dot density reduction process described above.

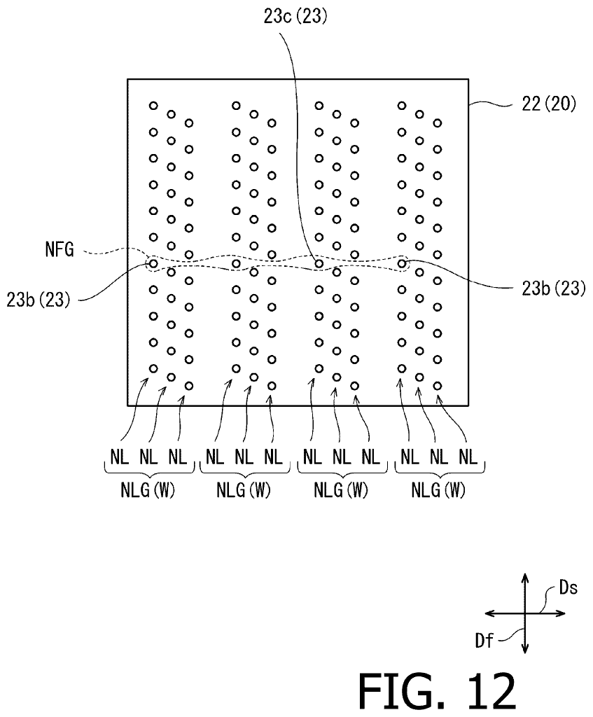

FIG. 12 illustrates another example of the dot density reduction process. When performing printing based on the second image data so that the dot density per pass is lower than that when printing is performed based on the first image data, the controller 50 may not use some of the second nozzles 23b as unused nozzles 23c. FIG. 12 shows an unused nozzle 23c as an example. In the ink amount increase process, the controller 50 executes an overlapping ejection process, in which the second nozzles 23b eject subsequent ink droplets so that they overlap the landing positions of the ink droplets ejected earlier by the second nozzles 23b. In the overlapping ejection process, the controller 50 disuses any of the second nozzles 23b in each of the multiple nozzle lines NL aligned in the conveying direction Ds, which are included in a nozzle group NFG consisting of multiple second nozzles 23b that have the same position in the conveying direction Df, respectively, and sets any of the second nozzles 23b as unused nozzles 23c. In this way, the dot density reduction process can be easily executed while avoiding a reduction in resolution when any of the multiple second nozzles 23b, which have the same position in the moving direction Ds, are set to be the unused nozzles 23c.

Alternatively, although the ink amount increase process is performed so that the ink amount after the increase becomes the value calculated by the above-described particular formula, the ink amount increase process may be performed so that the ink amount after the increase becomes the value calculated by the formula below. By multiplying the value calculated by the above-described particular formula by a factor of 0.8 to 1.2 to obtain the ink amount after the increase, it is possible to control the ink amount while also taking into account unforeseen conditions, such as sudden changes in environmental temperature.

Ink amount after increase=(normal ink amount)×{(dot density before dot density reduction process)/(dot density after dot density reduction process)}×K
where K is a factor ranging from 0.8 to 1.2.

In the above embodiment, the first and second nozzles 23a and 23b are provided as nozzles 23 separate and independent from each other, but the configuration is not necessarily limited to that of the above embodiment. The first and second nozzles 23a and 23b may be configured as the same nozzles 23. In such a case, when the dot density pertaining to the second image data exceeds the reference dot density, the nozzles 23 that eject ink to form the base layer can be regarded as the second nozzles 23b by executing the ink amount increase process, and the nozzles 23 that eject ink to form the base layer without executing the ink amount increase process can be regarded as the first nozzles 23a when the dot density above does not exceed the reference dot density.

In addition to the tanks and the heads for the basic color inks and the white ink in the above embodiment, tanks for storing particular color inks such as a red ink, a green ink, and a blue ink and ejection heads for ejecting these inks may be separately provided.

In the above embodiment, the heater 121 is provided in the second flow channel 13b and the heaters 122 are provided in the sub-tanks 18 connected to the second flow channels 13b, but the configuration is not necessarily limited to such a configuration, but only the heater 121 or the heaters 122 may be provided.

Furthermore, in the above embodiment, the ink amount increase process is performed for the second nozzles 23b that eject the white ink, but the configuration is not necessarily limited to such a configuration, but the ink amount increase process may be performed for nozzles configured to eject inks other than the white ink.

Furthermore, in the above embodiment, the reference dot density is set to 9.5×10⁵ (dots/inch²), but the reference dot density may be set to another value as appropriate.

What is claimed is:

1. A printing apparatus configured to eject ink to form an image, comprising:
an ejection head having:
first nozzles configured to eject ink to form a first base layer on a printing medium; and
second nozzles configured to eject ink to form a second base layer different from the first base layer on the printing medium; and
a controller configured to perform:
a first printing based on first image data, the first image data being data to form the first base layer, the first image data including data representing a first dot density per one pass;
a second printing based on second image data, the second image data being data to form the second base layer, the second image data including data representing a second dot density per one pass, the second dot density being lower than the first dot density; and
increasing an ink amount when the second printing is performed such that an ink amount per dot is increased compared to a case where the first printing is performed.

2. The printing apparatus according to claim 1,
wherein the controller causes the second nozzles to perform printing so that the dot density per one pass is lower, at irregular positions in a printing area of the printing medium, than a case where printing is performed based on the first image data.

3. The printing apparatus according to claim 1,
wherein the controller is configured to cause the ejection head to eject ink droplets such that landing positions of the ink droplets ejected later respectively overlap the landing positions of the ink droplets ejected previously, and
wherein a ratio of the number of overlapping ejections to the total number of ejections by the second nozzles when the ink amount per dot is increased is higher than a ratio of the number of overlapping ejections to the total number of ejections by the first nozzles when printing is performed based on the first image data.

4. The printing apparatus according to claim 1,
further comprising actuators configured to apply ejection pressures to the ink so that ink droplets are ejected from the nozzles, respectively,
wherein the controller is configured to differentiate waveforms to drive the actuators corresponding to the second nozzles from waveforms to drive the actuators corresponding to the first nozzles, respectively, when the ink amount per dot is increased.

5. The printing apparatus according to claim 4,
wherein the controller is configured to increase the number of pulses included in the ejection waveform to drive each of the actuators corresponding to the second nozzles to be more than the number of pulses included in the ejection waveform to drive each of the actuators corresponding to the first nozzles.

6. The Printing apparatus according to claim 4,
wherein the controller is configured to generates an ejection waveform so that a period of pulses of the ejection waveform to drive the actuators corresponding to the second nozzles coincides with the period or half-period of a natural oscillation of the actuators.

7. The printing apparatus according to claim 4,
wherein the controller is configured to increase an ejection voltage of the ejection waveform to drive the actuators corresponding to the second nozzles more than the ejection voltage of the ejection waveform to drive the actuator corresponding to the first nozzles.

8. The printing apparatus according to claim 1,
wherein the controller is configured to increase a temperature of the ink to be ejected from the second nozzles more than a temperature of the ink to be ejected from the first nozzles when the ink amount per dot is increased.

9. The printing apparatus according to claim 8,
wherein the controller is configured to heat the ink to be ejected from the second nozzles by the ejection head.

10. The printing apparatus according to claim 8,
further comprising a supply tank configured to supply the ink to be ejected from the second nozzles to the second nozzles,
wherein the controller is configured to heat the ink contained in the supply tank.

11. The printing apparatus according to claim 10,
further comprising:
ink flow channels connecting the supply source with the second nozzles; and
a heater configured to heat the ink flow channels,
wherein the controller is configured to cause the heater to heat the ink flow channels.

12. The printing apparatus according to claim 1,
wherein the controller is configured to perform determining whether the dot density of ink droplets to be ejected by the second nozzles per pass based on the second image data exceeds a reference dot density, and
wherein, when the controller determines that the dot density of ink droplets to be ejected by the second nozzles per pass based on the second image data exceeds the reference dot density, the controller is configured to increase the ink amount per dot.

13. The printing apparatus according to claim 1,
wherein, when printing is performed based on the second image data so that the dot density per pass is lower than the dot density per pass when printing is performed based on the first image data, the controller does not use some of the second nozzles among the plurality of second nozzles as unused nozzles.

14. The printing apparatus according to claim 13,
further comprising a carriage configured to move in a moving direction, the ejection head being held by the carriage,
wherein the multiple second nozzles are arranged in a direction intersecting with the moving direction to form multiple nozzle lines, the multiple nozzle lines being aligned in the moving direction,
wherein, in the increasing, the controller is configured to perform an overlapping process by:
causing the second nozzles to eject ink droplets such that landing positions of the ink droplets overlap landing positions of the ink droplets ejected earlier by the second nozzles; and
setting one or more of the second nozzles provided in each of the multiple nozzle lines and having the same position in the intersecting direction as the unused nozzles.

15. A printing apparatus configured to eject ink to form an image, comprising:
a first ejection head having first nozzles configured to eject ink to form a first base layer on a printing medium; and
a second ejection head having second nozzles configured to eject ink to form a second base layer different from the first base layer on the printing medium; and
a controller,
wherein a controller is configured to perform:
a first printing using the first ejection head to form the first base layer based on first image data, the first image data representing a first dot density per one pass; and
a second printing using the second ejection head to form the second base layer based on second image data, the second image data representing a second dot density per one pass, the second dot density being lower than the first dot density; and
increasing an ink amount when the second printing is performed such that an ink amount per dot is increased compared to a case where the first printing is performed.

16. A method of printing using a printing apparatus configured to eject ink to form an image, the printing apparatus having a first ejection head having first nozzles configured to eject ink to form a first base layer on a printing medium and a second ejection head having second nozzles configured to eject ink to form a second base layer different from the first base layer on the printing medium,
the method comprising:
a first printing using the first ejection head to form the first base layer based on first image data, the first image data representing a first dot density per one pass; and
a second printing using the second ejection head to form the second base layer based on second image data, the second image data representing a second dot density per one pass, the second dot density being lower than the first dot density,
wherein, when the second printing is performed, the method causes the second nozzles to perform printing with increasing an ink amount per dot compared to a case where the first printing is performed.

17. A non-transitory computer-readable recording medium for a printing apparatus configured to eject ink to form an image, the printing apparatus having a first ejection head having first nozzles configured to eject ink to form a first base layer on a printing medium and a second ejection head having second nozzles configured to eject ink to form a second base layer different from the first base layer on the printing medium,
wherein the recording medium stores computer-executable instructions which cause, when executed by the controller, the printing apparatus to perform:
a first printing using the first ejection head to form the first base layer based on first image data, the first image data representing a first dot density per one pass; and
a second printing using the second ejection head to form the second base layer based on second image data, the second image data representing a second dot density per one pass, the second dot density being lower than the first dot density; and
increasing an ink amount when the second printing is performed such that an ink amount per dot is increased compared to a case where the first printing is performed.
